(19) United States
(12) Patent Application Publication
(10) Pub. No.: US 2022/0058522 A1
(43) Pub. Date: Feb. 24, 2022

(54) MODEL LEARNING SYSTEM, MODEL LEARNING METHOD, AND SERVER

(71) Applicant: Toyota Jidosha Kabushiki Kaisha, Toyota-shi Aichi-ken (JP)

(72) Inventors: Daiki Yokoyama, Gotemba-shi (JP); Ryo Nakabayashi, Susono-shi (JP)

(73) Assignee: Toyota Jidosha Kabushiki Kaisha, Toyota-shi Aichi-ken (JP)

(21) Appl. No.: 17/405,515

(22) Filed: Aug. 18, 2021

(30) Foreign Application Priority Data
Aug. 24, 2020 (JP) 2020-140878

(51) Int. Cl. G06N 20/00; G06K 9/62

(52) U.S. Cl. CPC G06N 20/00; G06K 9/6252; G06K 9/6262; G06K 9/6256

(57) ABSTRACT

A model learning system includes a server and a plurality of vehicles. The server is configured so that when a model differential value showing a degree of difference before and after learning of a learning model used in one vehicle among the plurality of vehicles and trained based on training data sets acquired within a predetermined region is greater than or equal to a predetermined value, it instructs relearning of a learning model used in another vehicle among the plurality of vehicles present in that predetermined region to that other vehicle.

### CROSS REFERENCE TO RELATED APPLICATION

This application claims priority to Japanese Application No. 2020-140878 filed on Aug. 24, 2020, the entire contents of which are herein incorporated by reference.

### FIELD

The present disclosure relates to a model learning system, model learning method, and server.

### BACKGROUND

Japanese Unexamined Patent Publication No. 2019-183698 discloses to use a learning model trained in a server or a vehicle to estimate a temperature of an exhaust purification catalyst of an internal combustion engine.

### SUMMARY

Usually, a region in which each vehicle is used is limited to a certain extent. For example, if a private car, basically the private car is used in a sphere of everyday life of its owner. If a taxi, bus, or other commercial vehicle, basically the commercial vehicle is used in the service region of the business owning it. Therefore, when making a learning model used in each vehicle learn, it is possible to generate a learning model with a high precision corresponding to the features of the usage region of each vehicle (for example the terrain or traffic conditions etc.) by performing the learning using training data sets corresponding to the features of the usage region of each vehicle.

However, the features of a usage region may, for example, change along with the elapse of time due to changes in the terrain, new road construction, urban redevelopment, etc. For this reason, to maintain the precision of a learning model used in each vehicle, it becomes necessary to retrain the learning model at a suitable timing corresponding to the changes in the features of the usage region.

However, in the past, it was not possible to retrain a learning model at a suitable timing corresponding to changes in the features of the usage region.

The present disclosure was made focusing on such a problem and has as its object to retrain a learning model used in a vehicle at a suitable timing corresponding to changes in the features of the usage region.

To solve this problem, the model learning system according to one aspect of the present disclosure is provided with a server and a plurality of vehicles configured to be able to communicate with the server. The server is configured so that when a model differential value showing a degree of difference before and after learning of a learning model used in one vehicle among the plurality of vehicles and trained based on training data sets acquired within a predetermined region is greater than or equal to a predetermined value, it instructs relearning of a learning model used in another vehicle among the plurality of vehicles present in that predetermined region to that other vehicle.

Further, the server according to one aspect of the present disclosure is configured to be able to communicate with a plurality of vehicles and configured so that when a model differential value showing a degree of difference before and after learning of a learning model used in one vehicle among the plurality of vehicles and trained based on training data sets acquired within a predetermined region is greater than or equal to a predetermined value, it instructs relearning of a learning model used in another vehicle among the plurality of vehicles present in that predetermined region to that other vehicle.

Further, the model learning method according to one aspect of the present disclosure comprises a step of judging whether a model differential value showing a degree of difference before and after learning of a learning model used in one vehicle among a plurality of vehicles and trained based on training data sets acquired within a predetermined region is greater than or equal to a predetermined value and a step of relearning a learning model used in another vehicle among the plurality of vehicles present in that predetermined region in that other vehicle when the model differential value is greater than or equal to the predetermined value.

According to these aspects of the present disclosure, it is possible to retrain a learning model used in a vehicle at a suitable timing corresponding to changes in the features of the usage region.

### BRIEF DESCRIPTION OF DRAWINGS

FIG. 1 is a schematic view of a configuration of a model learning system according to an embodiment of the present disclosure.

FIG. 2 is a schematic view showing a hardware configuration of a vehicle according to an embodiment of the present disclosure.

FIG. 3 is a view showing one example of a neural network model.

FIG. 4 is a flow chart showing an example of processing performed between a server and one vehicle among a plurality of vehicles in a model learning system according to an embodiment of the present disclosure.

FIG. 5 is a flow chart showing an example of processing performed between a server and another vehicle among a plurality of vehicles in a model learning system according to an embodiment of the present disclosure.

### DETAILED DESCRIPTION

Below, referring to the drawings, an embodiment of the present disclosure will be explained in detail. Note that, in the following explanation, similar component elements will be assigned the same reference notations.

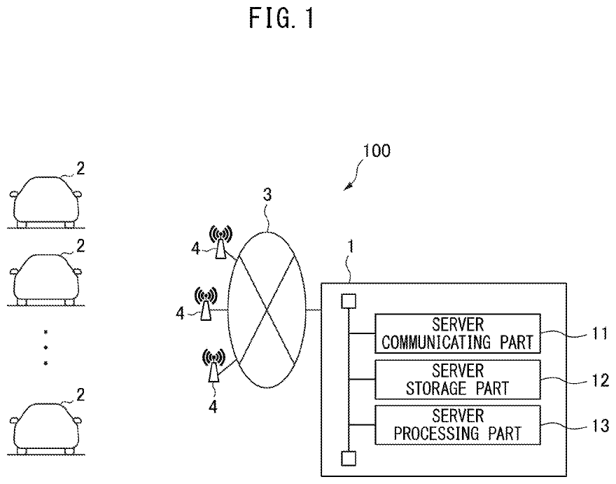

FIG. 1 is a schematic view of the configuration of a model learning system 100 according to an embodiment of the present disclosure.

As shown in FIG. 1, the model learning system 100 comprises a server 1 and a plurality of vehicles 2.

The server 1 is provided with a server communicating part 11, a server storage part 12, and a server processing part 13.

The server communicating part 11 is a communication interface circuit for connecting the server 1 with a network 3 through for example a gateway etc. and is configured to enable two-way communication with the vehicles 2.

The server storage part 12 has an HDD (hard disk drive) or optical recording medium, semiconductor memory, or other storage medium and stores the various types of computer programs and data etc. used for processing at the server processing part 13.

The server processing part 13 has one or more processors and their peripheral circuits. The server processing part 13 runs various types of computer programs stored in the server storage part 12 and comprehensively controls the overall operation of the server 1 and is, for example, a CPU (central processing unit).

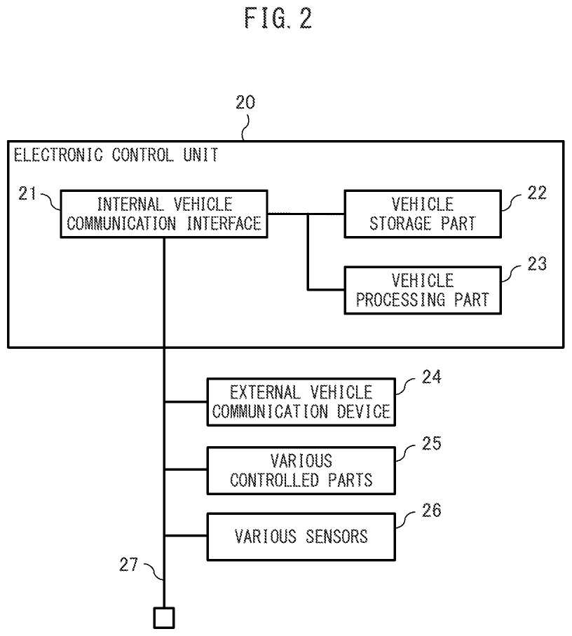

FIG. 2 is a schematic view showing a hardware configuration of the vehicle 2.

The vehicle 2 is provided with an electronic control unit 20, external vehicle communication device 24, for example an internal combustion engine or electric motor, actuators or other various types of controlled parts 25, and various types of sensors 26 required for controlling the various types of controlled parts 25. The electronic control unit 20, external vehicle communication device 24, and various types of controlled parts 25 and sensors 26 are connected through an internal vehicle network 27 based on the CAN (Controller Area Network) or other standard.

The electronic control unit 20 is provided with an interior vehicle communication interface 21, vehicle storage part 22, and vehicle processing part 23. The interior vehicle communication interface 21, vehicle storage part 22, and vehicle processing part 23 are connected with each other through signal wires.

The interior vehicle communication interface 21 is a communication interface circuit for connecting the electronic control unit 20 to the internal vehicle network 27 based on the CAN (Controller Area Network) or other standard.

The vehicle storage part 22 has an HDD (hard disk drive) or optical recording medium, semiconductor memory, or other storage medium and stores the various types of computer programs and data etc. used for processing at the vehicle processing part 23.

The vehicle processing part 23 has one or more processors and their peripheral circuits. The vehicle processing part 23 runs various types of computer programs stored in the vehicle storage part 22, comprehensively controls the various types of controlled parts mounted in the vehicle 2, and is, for example, a CPU.

The external vehicle communication device 24 is a vehicle-mounted terminal having a wireless communication function. The external vehicle communication device 24 accesses a wireless base station 4 (see FIG. 1) connected with the network 3 (see FIG. 1) through a not shown gateway etc. and is connected with the network 3 through the wireless base station 4. Due to this, two-way communication is performed with the server 1.

In each vehicle 2, in controlling the various types of controlled parts 25 mounted in the vehicle 2, for example, a learning model engaging in machine learning or other learning (artificial intelligence model) is used according to need. In the present embodiment, as the learning model, a neural network model using a deep neural network (DNN), convolutional neural network (CNN), etc. (below, referring to an “NN model”) is used for deep learning of the NN model. Therefore, the learning model according to the present embodiment can be said to be a trained NN model trained by deep learning. Deep learning is one type of machine learning such as represented by artificial intelligence (AI).

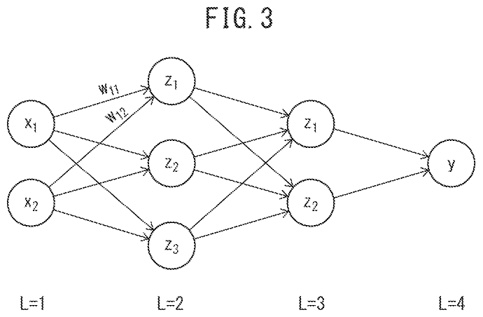

FIG. 3 is a view showing one example of the NN model.

The circle marks in FIG. 3 show artificial neurons. The artificial neurons are usually called “nodes” or “units” (in the Description, they are called “nodes”). In FIG. 3, L=1 indicates an input layer, L=2 and L=3 indicate hidden layers, and L=4 indicates an output layer. The hidden layers are also called “intermediate layers”. Note that, FIG. 3 illustrates an NN model with two hidden layers, but the number of hidden layers is not particularly limited. Further, the numbers of nodes of the layers of the input layer, hidden layers, and output layer are also not particularly limited.

In FIG. 3, x₁ and x₂ show the nodes of the input layer (L=1) and output values from the nodes while “y” shows the node of the output layer (L=4) and its output value. Similarly, z₁^{(L=2)}, z₂^{(L=2)}, and z₃^{(L=2)} show nodes of the hidden layer (L=2) and output values from the nodes, while z₁^{(L=3)} and z₂^{(L=3)} show nodes of the hidden layer (L=3) and output values from the nodes.

At the nodes of the input layer, the inputs are output as they are. On the other hand, at the nodes of the hidden layer (L=2), output values x₁ and x₂ of the nodes of the input layer are input, while at the nodes of the hidden layer (L=2), the corresponding weights “w” and biases “b” are used to calculate sum input values “u”. For example, in FIG. 3, a sum input value uₖ^{(L=2)} calculated at the node shown by zₖ^{(L=2)} (k=1, 2, 3) of the hidden layer (L=2) becomes like in the following formula (M is the number of nodes of the input layer).

$${u}_{k}^{( L = 2 )} = {\sum }_{m = 1}^{M} ( {x}_{m} \cdot {w}_{km}^{( L = 2 )} ) + {b}_{k} \qquad [ Mathematical 1 ]$$

Next, this sum input value uₖ^{(L=2)} is converted by an activation function “f” and output as the output value zₖ^{(L=2)}(=f(uₖ^{(L=2)})) from the node shown by zₖ^{(L=2)} of the hidden layer (L=2). On the other hand, the nodes of the hidden layer (L=3) receive input of the output values z₁^{(L=2)}, z₂^{(L=2)}, and z₃^{(L=2)} of the nodes of the hidden layer (L=2). At the nodes of the hidden layer (L=3), the respectively corresponding weights “w” and biases “b” are used to calculate the sum input values u(=Σz·w+b). The sum input values “u” are converted by an activation function in the same way and are output as the output values z₁^{(L=3)} and z₂^{(L=3)} from the nodes of the hidden layer (L3). The activation function is, for example, a Sigmoid function 6.

Further, at the node of the output layer (L=4), the output values z₁^{(L=3)} and z₂^{(L=3)} of the nodes of the hidden layer (L=3) are input. At the node of the output layer, the respectively corresponding weights “w” and biases “b” are used to calculate the sum input value u(Σz·w+b) or only the respectively corresponding weights “w” are used to calculate the sum input value u(Σz·w). For example, at the node of the output layer, an identity function is used as the activation function. In this case, the sum input value “u” calculated at the node of the output layer is output as is as the output value “y” from the output layer.

In this way, the NN model is provided with an input layer, hidden layers, and an output layer. If one or more input parameters are input from the input layer, one or more output parameters corresponding to the input parameters are output from the output layer.

As examples of the input parameters, for example, if using the NN model to control the internal combustion engine mounted in the vehicle 2, the current values of various parameters showing the operating state of the internal combustion engine such as the engine rotational speed or engine cooling water temperature, amount of fuel injection, fuel injection timing, fuel pressure, amount of intake air, intake temperature, EGR rate, and supercharging pressure may be mentioned. Further, as examples of the output parameters corresponding to such input parameters, estimated values of various parameters showing the performance of the internal combustion engine such as the concentration of NOx in the exhaust or the concentration of other substances and the engine output torque may be mentioned. Due to this, by inputting the current values of various parameters showing the operating state of the internal combustion engine into the NN model as input parameters, it is possible to acquire as output parameters the estimated values of various parameters (current estimated values and future estimated values) representing the performance of the internal combustion engine, so for example it is possible to control the internal combustion engine based on the output parameters so that the performance of the internal combustion engine approaches the desired performance. Further, if providing sensors etc. for measuring the output parameters, it is possible to judge a malfunction of the sensors etc. in accordance with the difference between the measured values and estimated values.

To improve the precision of the NN model, it is necessary to make the NN model learn. For learning of the NN model, a large number of training data sets including measured values of the input parameters and measured values (truth data) of the output parameters corresponding to the measured values of the input parameters are used. By using the large number of training data sets and using the known error backpropagation method to repeatedly update the values of the weights “w” and biases “b” inside the neural network, the values “w” and the biases “b” are learned and a learning model (trained NN model) is generated.

Here, usually, the region in which each vehicle is used is limited to a certain extent. For example, if a private car, basically the private car is used in a sphere of everyday life of its owner. If a taxi, bus, or other commercial vehicle, basically the commercial vehicle is used in a service region of a business owning it. Therefore, when making an NN model used in each vehicle learn (relearning it), by performing the learning using training data sets corresponding to the features of the usage region of each vehicle (for example the terrain or traffic conditions etc.), it is possible to generate a learning model with a high precision corresponding to the features of the usage region of each vehicle.

However, the features of a usage region may, for example, change along with the elapse of time due to changes in the terrain, new road construction, urban redevelopment, etc. For this reason, to maintain the precision of the learning model used in each vehicle, it becomes necessary to retrain the learning model at a suitable timing corresponding to changes in the features of the usage region.

However, in the past, it was not possible to make the relearning of a learning models be performed at a suitable timing corresponding to changes in the features of the usage region. As a result, a learning model before the changes of the features of the usage region ended up continuing to be used and a lowered precision learning model was liable to be used to control the various types of controlled parts 25 mounted in the vehicles 2.

Therefore, in the present embodiment, when at one vehicle 2 among the plurality of vehicles 2 the training data sets acquired within a predetermined time period in a predetermined region become greater than or equal to a predetermined amount, the training data sets are used to retrain the NN model used in the one vehicle 2, the NN model before relearning and the NN model after relearning are compared, and the difference between the two are rendered a numerical value as the “model differential value”. The model differential value is a parameter which becomes greater the greater the difference between the NN model before relearning and the NN model after relearning. For example, it is possible to input preset differential detection-use input parameters to the NN models before and after relearning and use the differential value of the output parameters obtained from the NN models at that time.

Further, if the model differential value is greater than or equal to a predetermined value, it is judged that the features in the predetermined region in which the training data sets were acquired (that is, usage region of one vehicle 2) are changing and other vehicles 2 among the plurality of vehicles 2 mainly used in the predetermined region are instructed to retrain their NN models.

Due to this, triggered by the model differential value before and after learning of the NN model in one vehicle 2 among a plurality of vehicles 2 becoming greater than or equal to a predetermined value, it is possible to instruct relearning of the learning models to other vehicles 2 used in the same region as the usage region of the one vehicle 2. For this reason, the learning models used in the vehicles 2 can be made to be retrained at suitable timings corresponding to changes in the features of the usage region.

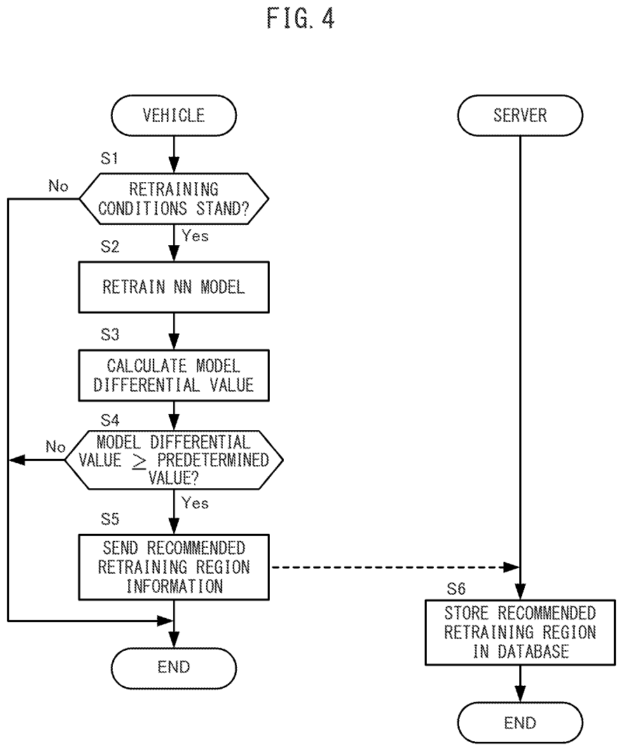

FIG. 4 is a flow chart showing one example of the processing performed between the server 1 and one vehicle 2 among a plurality of vehicles 2 in the model learning system according to the present embodiment.

At step S1, the electronic control unit 20 of the vehicle 2 judges whether relearning conditions of an NN model of a host vehicle stand. In the present embodiment, the electronic control unit 20 judges whether training data sets acquired within a predetermined time period in a predetermined region have become greater than or equal to a predetermined amount. If the training data sets acquired within the predetermined time period in the predetermined region become greater than or equal to the predetermined amount, the electronic control unit 20 proceeds to the processing of step S2. On the other hand, if the training data sets acquired within the predetermined time period in the predetermined region do not become greater than or equal to the predetermined amount, the electronic control unit 20 ends the current processing.

Note that since basically a certain time period is required for the features of a predetermined region to change due to changes in terrain, new road construction, urban redevelopment, etc., the predetermined time period is made a time period shorter than such a time period, that is, is made a time period in which it is envisioned that the features of the predetermined region will not greatly change. For example, it can be made the most recent several weeks or several months.

Further, if the vehicle 2 is a private car, the predetermined region can, for example, be made the inside of the sphere of everyday life of the owner of the private car judged from the past driving history. For example, if the vehicle 2 is a commercial vehicle, it is possible to make it the service region of the business owning the commercial vehicle. Further, the predetermined region can be made a preset certain region (for example, one section in the case of dividing the entire country into sections of several square kilometers) regardless of the type of the vehicle.

Further, in the present embodiment, the electronic control unit 20 of the vehicle 2 acquires training data sets while the vehicle is being driven (measured values of input parameters and measured values of output parameters of NN model) from time to time and stores the acquired training data sets in the vehicle storage part 22 linked with the timings of acquisition and places of acquisition. Further, in the present embodiment, if the amount of data of the stored training data sets exceeds a certain amount, the electronic control unit 20 of the vehicle 2 automatically discards the training data sets in order from the oldest ones on.

At step S2, the electronic control unit 20 of the vehicle 2 retrains the NN model used in the host vehicle by using training data sets acquired within the predetermined time period in the predetermined region.

At step S3, the electronic control unit 20 of the vehicle 2 compares the NN model before relearning and the NN model after relearning to calculate the model differential value.

In the present embodiment, the electronic control unit 20, as explained above, inputs a preset input parameter for detection of differences into the NN models before and after relearning and calculates the differential value of the output parameters obtained from the NN models at that time as the “model differential value”. However, the disclosure is not limited to such a method. For example, it is also possible to input a plurality of input parameters for detection of differences in the NN models before and after relearning and use the average value of the differential values of the plurality of output parameters obtained at that time as the model differential value or otherwise calculate the model differential value based on the differential values of the plurality of output parameters. Further, it is also possible to make the differential value of the weights “w” or biases “b” of the nodes of the NN models before and after relearning the model differential value and possible to calculate the model differential value based on the differential value of the weights “w” or biases “b” of the nodes such as an average value of the differential values of the weights “w” or biases “b” of the nodes.

At step S4, the electronic control unit 20 of the vehicle 2 judges whether the model differential value is greater than or equal to a predetermined value. If the model differential value is greater than or equal to the predetermined value, the electronic control unit 20 proceeds to the processing of step S5. On the other hand, if the model differential value is less than the predetermined value, the electronic control unit 20 ends the current processing.

At step S5, the electronic control unit 20 of the vehicle 2 sets a predetermined region in which the model differential value of the NN models before and after relearning becomes greater than or equal to the predetermined value (region in which training data sets used for relearning are acquired) as a “recommended relearning region” and sends recommended relearning region information including positional information for identifying the recommended relearning region etc. to the server 1.

At step S6, the server 1 receiving the recommended relearning region information stores the recommended relearning region in the database of the server storage part 12.

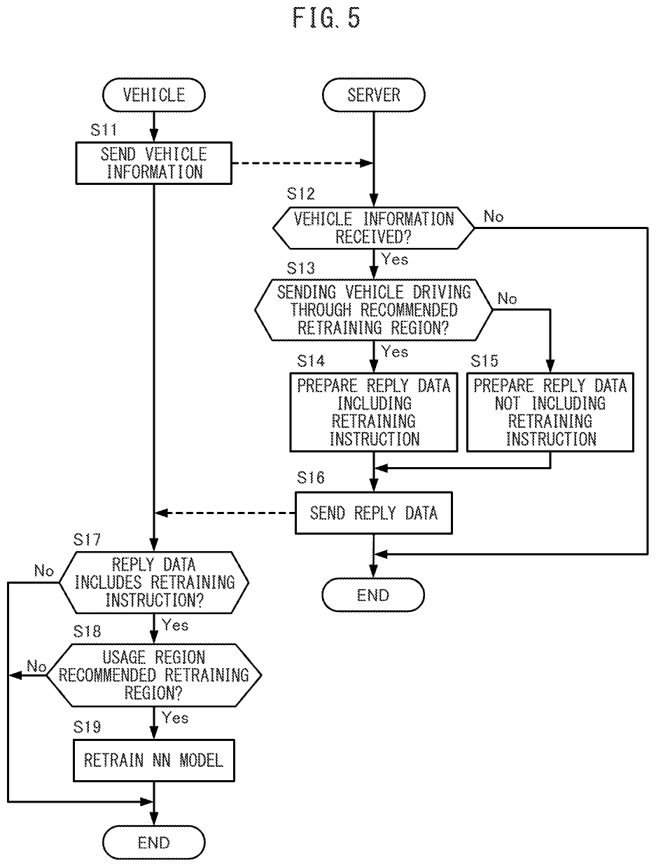

FIG. 5 is a flow chart showing one example of processing performed between the server 1 and another vehicle 2 among the plurality of vehicles in the model learning system according to the present embodiment.

At step S11, the electronic control unit 20 of the vehicle 2 periodically sends vehicle information including current positional information of the vehicle 2 (for example, the longitude and latitude of the vehicle 2) and identification information (for example, the registration number of the vehicle 2) to the server 1.

At step S12, the server 1 judges whether it has received the vehicle information. If receiving the vehicle information, the server 1 proceeds to the processing of step S13. On the other hand, if not receiving the vehicle information, the server 1 ends the current processing.

At step S13, the server 1 refers to the database storing the recommended relearning region and judges based on the current positional information included in the vehicle information whether another vehicle 2 sending that vehicle information (below, referred to as the “sending vehicle”) is driving through the recommended relearning region. If the sending vehicle 2 is driving through the recommended relearning region, the server 1 proceeds to the processing of step S14. On the other hand, if the sending vehicle 2 is not driving through the recommended relearning region, the server 1 proceeds to the processing of step S15.

At step S14, the server 1 prepares reply data including the recommended relearning region information and a relearning instruction.

At step S15, the server 1 prepares reply data not including a relearning instruction.

At step S16, the server 1 sends the reply data to the sending vehicle 2. In this way, when a model differential value showing a degree of difference before and after learning of a learning model used in one vehicle 2 among the plurality of vehicles 2 and trained based on training data sets acquired within the predetermined region is greater than or equal to the predetermined value, the server 1 sends another vehicle 2 among the plurality of vehicles 2 present in that predetermined region reply data including the recommended relearning region information and relearning instruction and instructs relearning of the learning model.

At step S17, the electronic control unit 20 of the sending vehicle 2 judges if the received reply data includes a relearning instruction. If the reply data contains a relearning instruction, the electronic control unit 20 proceeds to the processing of step S18. On the other hand, if the received reply data does not include a relearning instruction, the electronic control unit 20 ends the current processing.

At step S18, the electronic control unit 20 of the sending vehicle 2 judges whether the main usage region of the host vehicle is a recommended relearning region based on the recommended relearning region information included in the reply data. The main usage region of the host vehicle may also, for example, be judged from the past driving history of the host vehicle or may be set in advance by the owner etc. If the main usage region of the host vehicle is a recommended relearning region, the electronic control unit 20 proceeds to the processing of step S19. On the other hand, if the main usage region of the host vehicle is not a recommended retaining region, the electronic control unit 20 ends the current processing.

At step S19, the electronic control unit 20 of the sending vehicle 2 retrains the NN model of the host vehicle based on the relearning instruction using the most recent predetermined amount of training data sets acquired in the usage region while the vehicle was being driven (recommended relearning region) stored in the vehicle storage part 22. Note that, in relearning the NN model of the sending vehicle (other vehicle), it is also possible to receive the necessary training data sets from the server 1.

The model learning system 100 according to the embodiment explained above is provided with the server 1 and a plurality of vehicles 2 configured to be able to communicate with the server 1. Further, the server 1 is configured so that when a model differential value showing a degree of difference before and after learning of a learning model used in one vehicle 2 among the plurality of vehicles 2 and trained based on training data sets acquired within a predetermined region is greater than or equal to a predetermined value, it instructs relearning of a learning model used in another vehicle 2 among the plurality of vehicles 2 present in that predetermined region to that other vehicle.

Due to this, triggered by the model differential value before and after learning of the learning model used in one vehicle 2 among a plurality of vehicles 2 becoming greater than or equal to a predetermined value, it is possible to instruct relearning of the learning model to another vehicle 2 present in a predetermined region (for example, inside a usage region of the vehicle 2). It is assumed that the model differential value will become larger since the more the features in the predetermined region change (the more the features of the training data sets acquired in the predetermined region change), the greater the change in content of the NN model. For this reason, the learning model used in each vehicle 2 can be retrained at a suitable timing in accordance with a change of the features of the predetermined region.

Note that the model differential value, for example, can be made a differential value of output parameters output from the learning models before and after learning when predetermined input parameters are input to the learning models or a value calculated based on differential values of the output parameters (for example, the average value etc.) Further, the disclosure is not limited to this. It can be made the differential value of the weights or biases of the nodes of the learning models before and after learning or a value calculated based on the differential values of the weights or biases of the nodes (for example, the average value etc.)

Further, in the present embodiment, one vehicle 2 among the plurality of vehicles 2 is configured to train the learning model and calculate a model differential value when the training data sets acquired within a predetermined time period in a predetermined region become greater than or equal to a predetermined amount and to send the server 1 information corresponding to the result of calculation (recommended relearning region information).

Due to this, in one vehicle 2 among the plurality of vehicles 2, it is possible to periodically retrain the learning model to calculate the model differential value, so it is possible to periodically judge a change in the features in a predetermined region and possible to periodically judge whether another vehicle 2 has been instructed to retrain the learning model. Note that, this one vehicle 2 may also be a specific single vehicle among a plurality of vehicles 2, may also be a specific plurality of vehicles, or may be all of the vehicles.

Further, the present embodiment is configured so that when another vehicle 2 among the plurality of vehicles 2 is instructed to retrain the learning model from the server 1, if the usage region of the other vehicle 2 is within a predetermined region, it retrains the learning model used in the other vehicle 2.

Due to this, when the usage region of the other vehicle 2 is a region not related to a predetermined region, it is possible to keep the learning model used in the other vehicle 2 from being unnecessarily retrained.

Note that if viewing the present embodiment from a different perspective, in the present embodiment, the processing performed between the server 1 and the plurality of vehicles 2 can be understood as a model learning method comprising a step of judging whether a model differential value showing a degree of difference before and after learning of a learning model used in one vehicle among a plurality of vehicles and trained based on training data sets acquired within a predetermined region is greater than or equal to a predetermined value and a step of relearning a learning model used in another vehicle among the plurality of vehicles present in that predetermined region in that other vehicle when the model differential value is greater than or equal to the predetermined value.

Above, embodiments of the present disclosure were explained, but the above embodiments only show some examples of application of the present disclosure and are not intended to limit the technical scope of the present disclosure to the specific constitutions of the above embodiments.

For example, in the above embodiments, NN model relearning or calculation of the model differential value was performed in each vehicle 2, but the data required for relearning or calculation of the model differential value may also be suitably transmitted to the server 1 and NN model relearning or calculation of the model differential value may be performed in the server 1.

1. A model learning system comprising a server and a plurality of vehicles configured to be able to communicate with the server, in which model learning system,
the server is configured so that when a model differential value showing a degree of difference before and after learning of a learning model used in one vehicle among the plurality of vehicles and trained based on training data sets acquired within a predetermined region is greater than or equal to a predetermined value, it instructs relearning of a learning model used in another vehicle among the plurality of vehicles present in that predetermined region to that other vehicle.

2. The model learning system according to claim 1, wherein the model differential value is a differential value of output parameters which are output from the learning models before and after learning when inputting a predetermined input value into the learning models before and after learning or a value calculated based on the differential value.

3. The model learning system according to claim 1, wherein the model differential value is a differential value of weights and biases of nodes of the learning models before and after learning or a value calculated based on the differential value.

4. The model learning system according to claim 1, wherein the one vehicle is configured so that when the training data sets acquired within a predetermined time period in a predetermined region are greater than or equal to a predetermined amount, it trains the learning model to calculate the model differential value and sends information corresponding to the result of the calculation to the server.

5. The model learning system according to claim 1, wherein the other vehicle is configured so that when relearning of the learning model is instructed from the server, if a usage region of that other vehicle is within the predetermined region, the learning model used in that other vehicle is retrained.

6. The model learning system according to claim 1, wherein the predetermined region is a usage region of that one vehicle.

7. A server configured to be able to communicate with a plurality of vehicles, the server configured so that when a model differential value showing a degree of difference before and after learning of a learning model used in one vehicle among the plurality of vehicles and trained based on training data sets acquired within a predetermined region is greater than or equal to a predetermined value, it instructs relearning of a learning model used in another vehicle among the plurality of vehicles present in that predetermined region to that other vehicle.

8. (canceled)
